(19) United States
(12) Patent Application Publication
(10) Pub. No.: US 2024/0054474 A1
(43) Pub. Date: Feb. 15, 2024

(54) CACHED BALANCE INSPECTION IN REAL-TIME CARD TRANSACTIONS

(71) Applicant: Marqeta, Inc., Oakland, CA (US)

(72) Inventors: Ritesh GADEWAR, San Ramon, CA (US); Daniel OSBURN, Berlin (DE); Prashant PUNEKAR, Livermore, CA (US); Jatin SALLA, Pleasanton, CA (US)

(21) Appl. No.: 18/492,190

(22) Filed: Oct. 23, 2023

Related U.S. Application Data
(63) Continuation of application No. 17/114,345, filed on Dec. 7, 2020.

(51) Int. Cl. G06Q 20/32; G06Q 20/26; G06Q 20/34; G06Q 20/10

(52) U.S. Cl. CPC G06Q 20/3223; G06Q 20/26; G06Q 20/353; G06Q 20/108

(57) ABSTRACT

A transaction processing server may include a set of stored program rules specific to a supplier account and a cached balance value for a card account associated with an end user. The transaction processing server may receive an authorization request for a transaction between the end user and the supplier account. Additionally, the transaction processing server may send an approval request with transaction details to a supplier computer for approval to complete the transaction by the supplier account. The transaction processing server may also determine that the supplier computer is offline and, in response, determine to approve the authorization request at the transaction processing server on behalf of the supplier account based on the set of stored program rules specific to the supplier account and the cached balance value for the card account.

### CROSS-REFERENCE AND RELATED APPLICATIONS

This application is a Continuation of U.S. application Ser. No. 17/114,345, filed on Dec. 7, 2020, the entirety of which is incorporated herein by reference.

### TECHNICAL FIELD

One technical field of the present disclosure is computers programmed to execute high-speed, high-volume transactions and messaging. Another technical field is computer-implemented real-time memory cache management.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Online computer-implemented card transaction systems are architected to process thousands to millions of transactions, each involving a request, decision logic, transformation of data, and response, within brief time periods and with mandatory fixed maximum times for processing. These systems are termed real-time transaction systems because they are required to generate digital data requests, execute decision logic, transform data, and respond with other digital data within milliseconds to seconds while real-world activities are occurring, such as consumer purchases at a point of sale. Attributes of these systems include processing times and a scale of throughput and transaction volume that far exceed human capacity and require computer implementation.

The implementation of these services requires the use of distributed systems of computers in which end-user computing devices, point of sale systems, application servers or other systems of customers, servers of service providers, and servers of payment networks are independent and usually geographically distant from one another. Therefore, high-speed request-response message communication is required among the functional elements of the system. In many cases, a particular transaction can start, undergo processing, receive authorization or approval, and complete only when all such systems are online and responsive.

Thus, the requirement of these systems for real-time response and extremely high transaction throughput makes the systems sensitive to network outages, server outages, or other failures of units of the distributed systems. Unless protective measures are implemented, one computer or process will experience repeated timeouts as requests are sent and responses are not received. Systems operating in this manner consume unnecessary CPU cycles, network bandwidth, memory and storage usage to create requests, enter wait states, branch to failure code, and log errors. There is a need to reduce these and other technical consequences of failure or unreliability in high-speed, distributed transaction processing systems.

### SUMMARY

The appended claims may serve as a summary of the invention.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates a distributed computer system showing the context of use and principal functional elements with which one embodiment could be implemented.

FIG. 2 is a flow diagram of one embodiment of an algorithm that can be programmed to implement the disclosure.

FIG. 3A, FIG. 3B, FIG. 3C illustrate algorithms for other example processes that may be programmed for use in conjunction with FIG. 2.

FIG. 4A, FIG. 4B illustrate algorithms for other example processes that may be programmed for use in conjunction with FIG. 2.

FIG. 5 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

Embodiments are described in sections below according to the following outline:
1. General Overview
2. Structural Overview
3. Functional Overview
4. Implementation Example—Hardware Overview

### 1. GENERAL OVERVIEW

Card issuer-processors implement certain payment card processing functions using high-speed, cloud-based server computers and computing instances. The payment card may be a card, plastic credit card, charge card or other form of payment card. These systems support transaction services for Consumers, who are individuals who buy products or services from Customers, which are business entities. Requests, data, and responses concerning the movement of money or value among accounts occur using Payment Networks. Some services also act as an issuer of virtual payment cards to Consumers on behalf of Customers. Issuing banks also issue cards and link cards to Consumer accounts. Some services also act as a Payment Processor and Card Issuing Proxy for Customers so that Customers do not need to implement these functions themselves. All the aforementioned parties use distributed systems of computers that are linked by open internetworks and private, secure payment networks.

Just-in-Time Funding is a service commercially available from the issuer-processor Marqeta, Inc. and has been computer implemented in part for the purpose of reducing excess consumption of network bandwidth, CPU cycles, memory, and storage in executing certain services. The service also helps Customers avoid tying up large amounts of working capital in a reserve account. In one implementation, JIT Funding software is programmed to automatically cause moving funds or value from a funding source into the appropriate settlement account at transaction time. Customers control which transactions are authorized and funded.

In one embodiment, the JIT Funding software executes on servers, accessible from external systems of Customers, that can fund a card balance of a Consumer, in real-time at the time that a Consumer is attempting a purchase, and within short, fixed required response times, from an account that the Consumer has previously linked to a card. Customers can approve or deny each transaction in real time based on programmed business logic executed at Customer servers. Better cash flow management is one result because Customer can fund cards in real time. Each card maintains a zero balance until Customer authorizes the release of funds. Faster reconciliations are achieved because Customers can inject custom metadata into each transaction that will match your order or ledger system records. Consequently, these techniques reduce the consumption of network bandwidth, CPU cycles, memory, and storage by eliminating certain categories of transaction denials.

Embodiments may be used with computers programmed to implement JIT funding using several different approaches or modes. In a first approach, Customers programmatically manage payment approvals by transmitting messages to the issuer-processor computer from a supplier computer that define when, where, and how much a cardholder can spend with their card ahead of time. Parameter definitions in the messages are digitally stored as attributes of card account records at the issuer-processor computer. However, the Customer does not allow or deny individual transactions as they happen. Instead, based on the digitally stored attributes, as transactions occur, the issuer-processor approves or denies transaction requests.

In a second approach, the supplier computer is programmed to control each transaction as it happens. The issuer-processor computer, in response to receiving a card payment authorization request from a payment network computer, transmits a message containing transaction details to a supplier computer. The supplier computer is programmed to determine whether to allow or deny the funding based on local stored program rules or programmed policy. The supplier computer transmits a response message to the issuer-processor computer that specifies whether to allow or deny the funding, and optionally includes other metadata concerning the transaction.

In a third approach, the second approach is executed with variants in processing at the issuer-processor computer that enables Customers to ensure business continuity when their infrastructure is offline or unavailable, for example, due to high transaction volumes or outages. In the third approach, the issuer-processor computer is programmed to authorize and fund transactions using stored program rules that are established in advance. The issuer-processor computer also stores, in a digital storage device or database, copies of state data, such as any webhooks that could not be transmitted immediately because the supplier computer is offline. The webhooks may be transmitted later, with the storage ensuring that account balances correspond with activity that occurred while the supplier computer was offline. State data may be organized or formatted using records, rows, data structures, or data objects other than webhooks.

In an embodiment, the third approach further comprises using server computers of a card issuer-processor to transmit payment card authorization responses to payment networks based on retrieving a cached card balance value that has been cached at the card issuer-processor in response to a request of a supplier computer that specifies the balance value to cache. A cached card balance for each card or account is digitally stored at the card issuer-processor in association with card account data that is sufficient to identify a card or card account. When a payment authorization message is received at the card issuer-processor computer, and the supplier computer is offline as indicated by a lack or response or timeout after a request message is sent to the supplier computer, the card issuer-processor determines whether the cached balance is sufficient to fund the proposed transaction.

If the cached balance is sufficient, then the issuer-processor computer authorizes the transaction on behalf of the supplier computer. If the cached balance is insufficient, then the card issuer-processor refuses the transaction on behalf of the supplier computer. In either case, the issuer-processor computer stores records of the balance for later transmission to the supplier computer. Consequently, card issuer-processors can respond to authorization requests of merchants and/or card networks when supplier computers are offline and without accessing true card balance data for cards. Furthermore, the use of CPU resources, network bandwidth, memory and other storage are reduced because the issuer-processor computer is not required to transmit request messages and wait in timeout cycles when the supplier computer is offline.

In one aspect, a computer-implemented method, comprises, using a transaction processing server computer, receiving a payment charge authorization request that is associated with a transaction and with a supplier that is associated with a supplier account, the payment charge authorization request identifying a card account having a card balance attribute having a zero value, the card account having a cached balance value that has been cached at the transaction processing server; determining that the supplier account is associated with a supplier computer that is offline; in response to determining that the cached balance value is greater than or equal to an amount of the transaction, automatically determining to fund the card balance record to complete the transaction; creating and transmitting, to a funding source computer, a programmatic call to transfer funds from a funding account that was previously linked to the card; transmitting, to a payment network computer, a response message specifying an approval of the transaction; updating, in a database of a digital storage device, the cached balance value by debiting the amount of the transaction; creating and storing, in the database of a digital storage device, one or more account balance values as they existed during the foregoing processing; the payment charge authorization request being one of thousands of other payment charge authorization requests that the transaction processing server computer receives from the payment network computer and processes concurrently in computer memory in real time.

In another aspect, a computer-implemented method, comprises, using a transaction processing server computer, receiving a payment charge authorization request that is associated with a transaction and a supplier that is associated with a supplier account, the payment charge authorization request identifying a card account having a card balance attribute having a zero value, the card account having a cached balance value that has been cached at the transaction processing server in response to a prior configuration request of the supplier account; determining that the supplier account is associated with a supplier computer that is offline; based upon a set of stored program rules that are associated with and specific to the supplier account: in response to determining that the cached balance value is greater than or equal to an amount of the transaction, automatically determining to fund the card balance record to complete the transaction; creating and transmitting, to a funding source computer, a programmatic call to transfer funds from a funding account that was previously linked to the card; transmitting, to a payment network computer, a response message specifying an approval of the transaction; updating, in a database of a digital storage device, the cached balance value by debiting the amount of the transaction; creating and storing, in the database of a digital storage device, one or more webhooks specifying card state values and account balance values as they existed during the foregoing processing; the payment charge authorization request being one of thousands of other payment charge authorization requests that the transaction processing server computer receives from the payment network computer and processes concurrently in computer memory in real time, the transaction processing server computer being programmed to execute the foregoing steps for the payment charge authorization request and the other payment charge authorization requests within a maximum response time per request of three (3) seconds.

In one feature, the method further comprises determining that the supplier computer is online, and in response, retrieving from the database and transmitting to the supplier computer the state data or webhooks and the cached balance value for transactions that occurred while the supplier computer was offline. In another feature, the method further comprises: when the supplier computer is online, receiving a programmatic call to update the cached balance value, the call including a new cached balance value; updating, in the database of a digital storage device, the cached balance value by writing the new cached balance value to the card account.

In a further feature, the method further comprises, in response to receiving the payment charge authorization request, determining that the supplier computer is online, and in response thereto: programmatically transmitting a second request message comprising transaction details to the supplier computer; receiving a second response message from the supplier computer, the second response message specifying to allow or deny the funding, the second response message having been formed based on applying programmatic rules at the supplier computer, the second response message including a new cached balance value; updating, in the database of a digital storage device, the cached balance value by writing the new cached balance value to the card account.

In still another feature, the method of claim 1 comprises: when the supplier computer is online, receiving a programmatic call to retrieve the cached balance value; querying the database of a digital storage device to obtain the cached balance value for the card account; forming and transmitting a third response message to the supplier computer that includes the cached balance value.

In any of the foregoing features, the payment charge authorization request is received from the payment network computer.

### 2. STRUCTURAL OVERVIEW

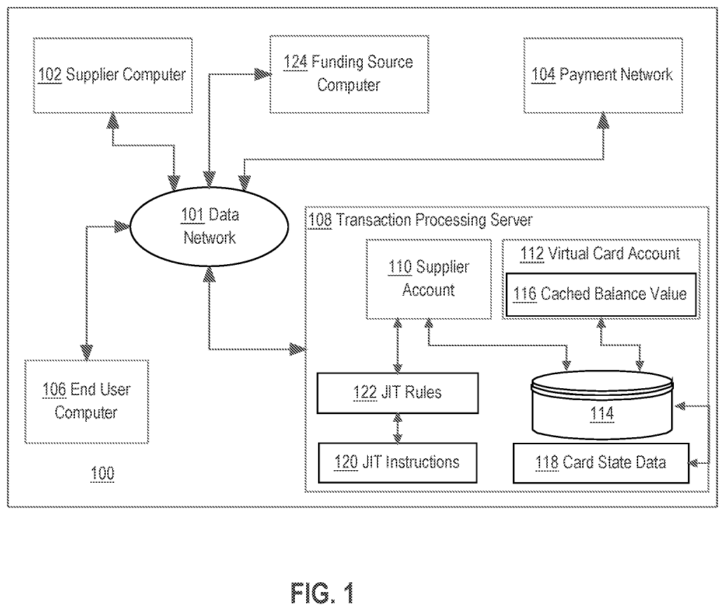

FIG. 1 illustrates a distributed computer system showing the context of use and principal functional elements with which one embodiment could be implemented.

In an embodiment, a distributed computer system 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

In an embodiment, computer system 100 comprises a data network 101 that is communicatively coupled to a supplier computer 102, payment network 104, end user computer 106, transaction processing server 108, and funding source computer 124. For purposes of illustrating a clear example, FIG. 1 shows one instance of each of the foregoing functional units, but in other embodiments, one or more of the functional units may be implemented with two or more units.

Each of the supplier computer 102, payment network 104, transaction processing server 108, and funding source computer 124 may be implemented using one or more server-class computers, clusters, virtual machines, or other computing devices. For example, transaction processing server 108 may be implemented using a fault-tolerant, scalable set of virtual computing instances in a private datacenter, public datacenter or cloud computing facility with a number of central processing units sufficient to service thousands to millions of concurrent transaction requests from the payment network 104 and originating from thousands to millions of end user computers 106, supplier computers 102, or points of sale.

Supplier computer 102 may be owned or operated by, or associated with, a supplier of goods or services, such as a merchant, to an end user who is associated with end user computer 106. In other cases, supplier computer 102 may represent a point of sale terminal at which an individual end user appears in person to conduct a transaction. The supplier or merchant may have a customer relationship with an entity, such as a card issuer-processor, that owns, operates, or is associated with the transaction processing server 108. However, a customer relationship is not required.

In one embodiment, an end user computer 106 is used and represents a mobile computing device, smartphone, laptop computer, desktop computer, or workstation that is associated with an individual end user. In some embodiments, end user computer 106 is programmed with an operating system having an internet software stack that can communicate with data network 101 using protocols such as HTTP over TCP/IP, and has an internet browser that can communicate with supplier computer 102 to transfer requests and responses using HTTP, application protocols implemented using apps on the end user computer, or other techniques. The end user computer 106 may be one source of introducing a card number for a transaction into the processes described herein, but other embodiments may receive card number or other transaction details through programmatic calls or other systems or computers.

Data network 101 broadly represents one or more local area networks, wide area networks, internetworks, or a combination thereof, which are communicatively coupled via any of wired or wireless, terrestrial or satellite network links.

Payment network 104 is a secure, private network for communication of payment protocol messages between the computers of authorized parties such as banks, payment clearinghouses, merchants, card issuers, and card processors. Because payment network 104 comprises a plurality of computers, software, and specialized networking gear, the terms “payment network” and “payment network computer” may be used interchangeably for convenience to refer to all functional elements in a payment network.

Funding source computer 124 represents a mobile computing device, smartphone, laptop computer, desktop computer, or workstation that is associated with a funding source such as a bank, savings and loan, credit union, private lender, or other source for funding transactions. In one embodiment, funding source computer 124 and transaction processing server 108 are integrated or associated with the same issuer-processor entity. Funding source computer 124 broadly represents all computer-implemented functional elements of such an institution, including databases or data repositories that hold account data, instrument data and value data for accounts, monetary instruments in accounts, and funds or value in accounts.

Transaction processing server 108 may be one or more server computers and/or virtual machine instances that are programmed to implement the functions that are further described herein. In one embodiment, transaction processing server 108 is owned or operated by a card issuer-processor, but other entities also may implement functionally equivalent computers or programs. The transaction processing server 108 may be architected with load balancing routers, multiple processors, clusters, or virtual machine instances, work queues, multithreaded programming, and parallel processing to operate with real-time response to requests from payment network 104 as end user computers 106 or supplier computers 102 are conducting transactions at the scale of thousands to millions of requests per second.

In one embodiment, transaction processing server 108 comprises a digital storage device or database 114 that is programmed with a database schema or other form of organized, high-speed, digital storage and manages a supplier account 110, card account 112 with cached balance value 116, and card state data 118. Database 114 may represent any digital data storage device or repository including combinations of database clusters, relational databases, object storage or other repositories.

Supplier account 110 represents a digitally stored association of data that describes a supplier, such as the supplier associated with supplier computer 102. Supplier accounts 110 enable the system to differentially process stored program rules for different suppliers to implement different policy concerning approval of transactions, JIT funding of transactions, use of cached balances, and/or denial of transactions. A supplier may supply goods, services, or a combination thereof to end users associated with end user computer 106, a point of sale, or other entities or institution. A supplier may be a retailer, reseller, value-added reseller, distributor, or other entity in a supply chain or manufacturing chain. A supplier may deal in tangible goods and/or intangible goods, using physical retail, resale, or distribution facilities and/or virtual, online stores, shopping carts, catalogs, or other facilities.

Card account 112 represents a virtual payment card that has been issued to a party such as an end user who is associated with end user computer 106. Each card account 112 is associated with a digitally stored cached balance value 116, which represents an amount of value that is available for payment of purchases for which the card is presented.

Card state data 118 represents a digitally stored set of attributes or values for a state of a card, its balance, and other attributes of a card account. Card state data 118 enables the system to maintain a record of card state when supplier computer 102 is offline and cannot be messaged or programmatically queried to obtain a funding decision, authorization decision, or approval decision. By digitally storing the card state data 118 at database 114, the transaction processing server 108 may be programmed to transmit the card state data to the supplier computer 102 when it returns online, enabling synchronization of card account details between the transaction processing server and the supplier computer. In an embodiment, the stored card state data 118 is associated with the particular supplier account 110 of a supplier computer that was offline, using a supplier identifier value, other identifier, or pointer. In some embodiments, card state data 118 comprises a set of webhooks that the JIT instructions 120 generate as they execute.

In one embodiment, transaction processing server 108 further comprises JIT instructions 120, which are programmed to execute just-in-time function operations for the card account 112, which normally holds a zero balance until a transaction occurs. In one embodiment, transaction processing server 108 comprises a set of stored program JIT rules 122, which are associated with a particular supplier account 110, and specify logic which, when applied to the attributes of a specific transaction, enables the transaction processing server to determine whether to approve and/or fund a particular transaction.

For purposes of clarity, FIG. 1 illustrates one instance of the supplier account 110, card account 112 with cached balance value 116, card state data 118, JIT instructions 120, and JIT rules 122. In practical embodiments, transaction processing server 108 may be architected with sufficient CPU power, memory, and storage to process thousands of supplier accounts 110 with corresponding sets of JIT rules 122, as well as millions of card accounts 112 and associated cached balance values 116 and card state data 118.

Computer system 100 is a high-speed, high-throughput, scalable system planned for real-time processing of card payment transactions as they occur. In this context, “real-time” response refers to receiving a request from payment network 104 to approve or decline a transaction, executing decision logic at transaction processing server, transmitting messages to one or more of supplier computer 102, funding source computer 124, and payment network 104 to obtain decisions or data, and transmitting a response to the payment network within an amount of time that end users or suppliers will tolerate as reasonable to conduct a transaction. In some embodiments, the total time for executing the foregoing steps is three (3) seconds to seven (7) seconds.

### 3. FUNCTIONAL OVERVIEW

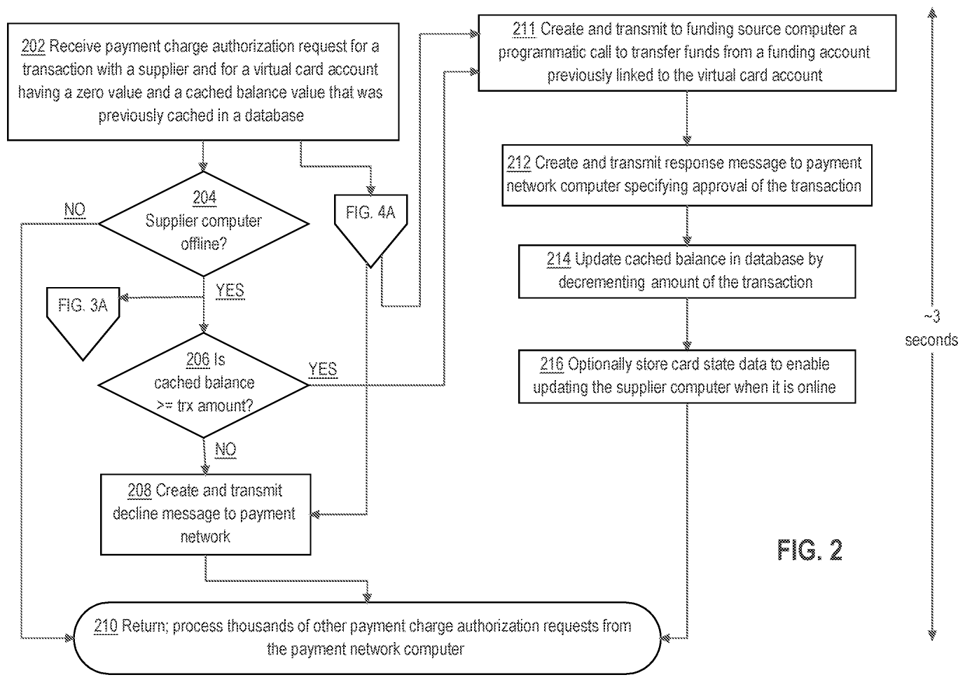

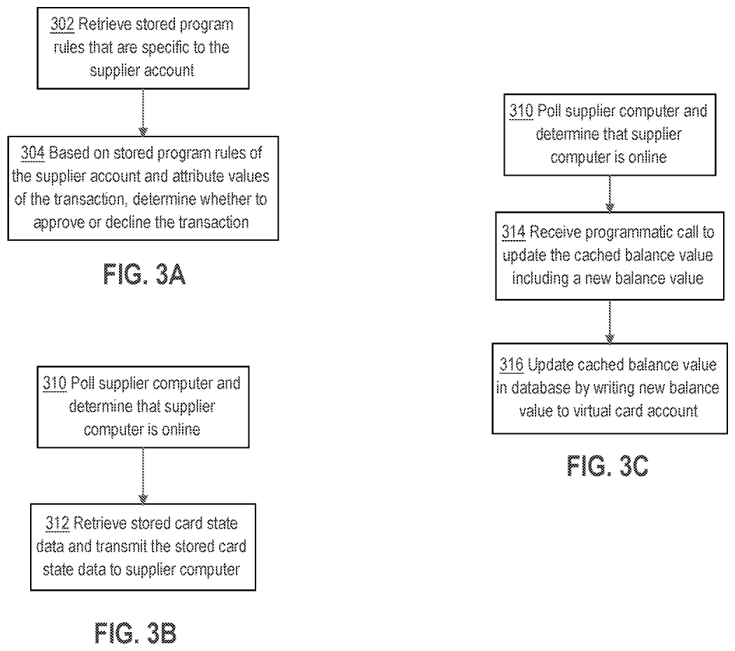

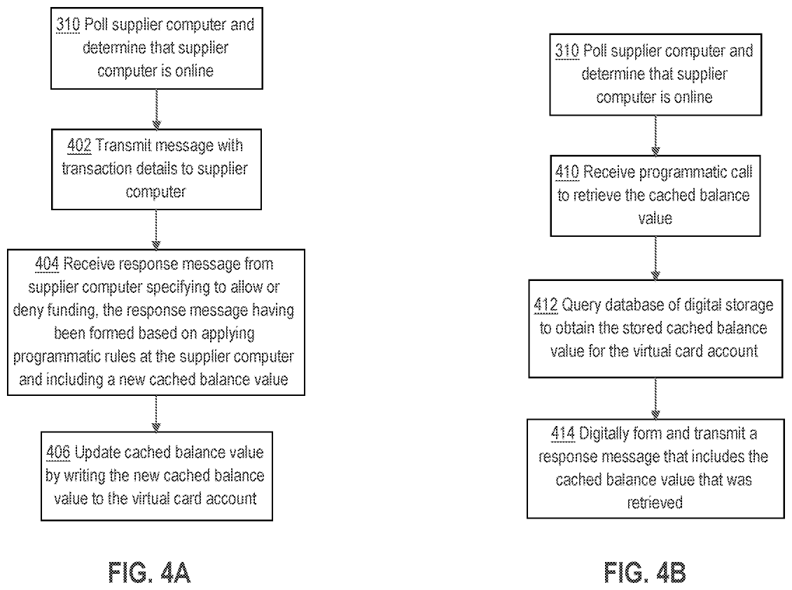

FIG. 2 is a flow diagram of one embodiment of an algorithm that can be programmed to implement the disclosure. FIG. 3A, FIG. 3B, FIG. 3C illustrate algorithms for other example processes that may be programmed for use in conjunction with FIG. 2. FIG. 4A, FIG. 4B illustrate algorithms for other example processes that may be programmed for use in conjunction with FIG. 2. In one embodiment, JIT instructions 120 of transaction processing server 108 are programmed to execute the functions illustrated in FIG. 2, FIG. 3A, FIG. 3B, FIG. 3C, FIG. 4A, FIG. 4B.

FIG. 2 and each other flow diagram herein is intended as an illustration at the functional level at which skilled persons, in the art to which this disclosure pertains, communicate with one another to describe and implement algorithms using programming. The flow diagrams are not intended to illustrate every instruction, method object or sub-step that would be needed to program every aspect of a working program, but are provided at the same functional level of illustration that is normally used at the high level of skill in this art to communicate the basis of developing working programs.

Referring first to FIG. 2, in an embodiment, at block 202 a process is programmed to receive a payment charge authorization request that is associated with a transaction and a supplier that is associated with a supplier account. For example, transaction processing server 108 is programmed to receive a payment charge authorization request from payment network 104 that originated from a transaction of end user computer 106 and supplier computer 102. In an embodiment, the payment charge authorization request identifies a card account 112 having a card balance attribute having a zero value. The card account 112 also has a separate cached balance value 116. Thus, the system maintains both a current card balance value, which is zero, and a stored, cached balance value 116 that may be referenced upon request.

The cached balance value 116 is cached at the transaction processing server 108 before the payment charge authorization request was received. For example, the cached balance value 116 may have been cached in response to a prior configuration request from the supplier computer 102 or referencing the supplier account 110 and a particular card account 112. In some embodiments, the transaction processing server 108 implements a set of programmatic calls, organized as an application programming interface (API), that other computers, software, or services may be programmed to call over the data network 101. For example, transaction processing server 108 may implement an API with a cached balance request call that supplier computer 102 may transmit to cache a particular cached balance value 116 for a particular card account 112.

After block 202, optionally, transaction processing server 108 may be programmed to transfer control to FIG. 4A, and after processing FIG. 4A, to transfer control to block 208. Both FIG. 4A and block 208 are described in other sections below.

At block 204, the process is programmed to test or determine whether the supplier computer is offline. Testing or determining at block 204 may comprise inspecting a stored flag value, retrieving the supplier account 110 for the supplier computer 102 and inspecting a column value or attribute value that specifies offline status, and/or sending an inquiry message such as a PING message and waiting for a response within a specified timeout. The specific programmed technique that is used to execute block 204 is not critical.

If the supplier computer 102 is online such that block 204 is negative or NO, then control transfers to block 210 and the process exits or returns to other methods, routines, logic or programs. In general, the processing of transactions when supplier computer 102 is online, and therefore capable of responding to requests concerning approval of transactions, denial of transactions, and/or funding transactions, is orthogonal to this disclosure. A selected set of integrations with online operation of supplier computer 102 are disclosed in other sections hereof.

If the supplier computer 102 is offline such that block 204 is positive or YES, then control transfers to block 206, which is programmed to test or determine whether the cached balance for the payment card involved in the transaction is greater than or equal to the transaction amount. Optionally, before block 206, control may transfer to FIG. 3A, which is described separately in other sections.

If the test or determination of block 206 is negative or NO, then control transfers to block 208, which is programmed to create and transmit a decline message to the payment network. Control then transfers to block 210, which has been previously described.

If the test or determination of block 206 is positive or YES, then control transfers to block 211, which is programmed to create and transmit to a funding source computer a programmatic call to transfer funds from a funding account that was previously linked to the card account. Thus, with the combination of block 206 and block 211, the cached balance value stored at transaction processing server 108 is used to determine that the transaction can be funded from an authorized funding source, based upon a cached, previous representation of the supplier computer 102 that the balance is available. The process of FIG. 2 does not directly result in the moving of value or funding but acts to request other functional entities in computer system 100 to execute those operations.

At block 212, the process is programmed to create and transmit a response message to the payment network 104 specifying approval of the transaction. At block 214, the process is programmed to update the cached balance value in the database by decrementing the amount of the transaction.

Control then may transfer to block 216 at which card state data is optionally stored, for example, in database 114. Storing card balance data and/or other card state data may enable the transaction processing server 108 to update the supplier computer 102 when the supplier computer becomes available online.

As noted in block 210, the process of FIG. 2 may include processing thousands of other payment charge authorization requests from the payment network 104. Thus, the payment charge authorization request received at block 202 may be one of thousands of other payment charge authorization requests that the transaction processing server computer 108 receives from the payment network 104 and processes concurrently in computer memory in real time. The transaction processing server 108 may be programmed to concurrently process other kinds of requests, at similar scale, from sources other than payment network 104.

Furthermore, in some embodiments, the transaction processing server 108 may be programmed to execute the foregoing steps for the payment charge authorization request and the other payment charge authorization requests within a maximum response time per request of three (3) seconds, as shown in FIG. 2. In other embodiments, the system may be programmed to enforce a maximum response time per request of three to seven seconds. Other time limits may be used in other embodiments.

The enforcement of these time limits may be programmed, for example, using a clock thread that executes asynchronously with respect to FIG. 2 and watches or monitors timestamp values that are entered in a log file or in memory at block 202, 208, 212, and/or 216 to determine whether the elapsed time for executing the process exceeds the programmed time limit. If the clock thread determines that the elapsed time exceeds the programmed limit, then the clock thread may be programmed to interrupt or halt the main thread of FIG. 2 and return a failure message.

3.1 Using Decision Rules in Combination with Cached Balance Processing

Referring now to FIG. 3A, in one embodiment, at block 302, the transaction processing server 108 may be programmed to retrieve one or more stored program rules that are specific to the supplier account involved in or associated with a particular transaction. To retrieve the stored program rules may comprise addressing a particular area of main memory in which rules have been previously stored or cached or may comprise retrieving the rules from a rules table or record of a database, in real time or not in real time. In an embodiment, the system stores, in database 114, a set of JIT rules 122 for each supplier account 110.

At block 304, the process is programmed to determine, based on the stored program rules of the supplier account and attribute values of the transaction, whether to approve or decline the transaction. In an embodiment, the transaction processing server 108 may be programmed to implement the API that has been previously described with a call to provide or receive a payment charge authorization request. The request may include a payload consisting of a JSON block formatted with a plurality of attribute values that may serve as the basis of programmatic decisions of whether to approve, deny, and/or fund a transaction on a JIT basis. The stored program rules may define conditions or tests for approval or denial; one example is to approve a transaction when all attributes of a payment card match the details of an account stored at the issuer-processor, except for street address. Thus, supplier-defined rules may be used in addition to the process of FIG. 2 as part of the decision logic to approve, deny, and/or fund a transaction.

3.2 Transmitting State Data after Supplier Returns Online

Referring now to FIG. 3B, in an embodiment, at block 310, transaction processing server 108 may be programmed to receive a programmatic call from the supplier computer 102, such as an API call, and determine that the supplier computer is online. Or, block 310 may comprise receiving a notification message, alert, or other programmatic message from the supplier computer 102 with one or more values or attributes that are sufficient to indicate or announce that the supplier computer is online. The specific mechanism, by which the process or transaction processing server 108 determines the online/offline status of supplier computer 102 is not critical.

At block 312, in an embodiment, transaction processing server 108 is programmed to retrieve the stored card state data 118 that is associated with the particular supplier account 110 of a supplier computer 102 that was offline and transmit the stored card state data to the supplier computer. The supplier computer 102 is expected to implement program logic to read the stored card state data and synchronize records, metadata, or other storage with the card state data that is received, or otherwise use the card state data to recover from the offline state.

3.3 Updating Cached Balance Values

Referring now to FIG. 3C, in an embodiment, transaction processing server 108 is programmed to execute block 310 in the same manner as described for FIG. 3B to discover, by any of various means that the supplier computer 102 is online. Thereafter, at block 314, transaction processing server 108 is programmed to receive a request, message, or programmatic call to update the cached balance value, the call including a new cached balance value. In response, the transaction processing server 108 is programmed to update, in the database of a digital storage device, the cached balance value 116 by writing the new cached balance value to the card account 112.

3.4 Injecting a Cached Balance Update in a Response in JIT Funding Processing

Referring now to FIG. 4A, in an embodiment, transaction processing server 108 is programmed to execute block 310 in the same manner as described for FIG. 3B to discover, by any of various means that the supplier computer 102 is online. In some embodiments, block 310 of FIG. 4A may execute asynchronously with respect to FIG. 2 and may occur in response to or near in time to receiving the payment charge authorization request at block 202. Thereafter, at block 402, transaction processing server 108 is programmed to transmit a request message comprising transaction details to the supplier computer 102.

At block 404, the transaction processing server 108 is programmed to receive a second response message from the supplier computer, the second response message specifying to allow or deny the funding, the second response message having been formed based on applying programmatic rules at the supplier computer, the second response message including a new cached balance value. Thus, via block 404, transaction processing server 108 may integrate decision logic of the supplier computer 102, using rules executed at the supplier computer and also including a cached balance update value as part of the response.

In response, at block 406, transaction processing server 108 is programmed to update, in the database of a digital storage device, the cached balance value by writing the new cached balance value 116 to the card account 112.

3.4 Balance Query and Response

Referring now to FIG. 4B, in an embodiment, transaction processing server 108 is programmed to execute block 310 in the same manner as described for FIG. 3B to discover, by any of various means that the supplier computer 102 is online. In some embodiments, FIG. 4B may execute asynchronously with respect to FIG. 2.

At block 410, transaction processing server 108 is programmed to receive a programmatic call to retrieve the cached balance value. At block 412, in response, transaction processing server 108 is programmed to query the database 114 to obtain the cached balance value 116 for the card account 112.

At block 414, transaction processing server 108 is programmed to form and transmit a response message to the supplier computer 102 that includes the cached balance value.

### 4. IMPLEMENTATION EXAMPLE—HARDWARE OVERVIEW

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques.

The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

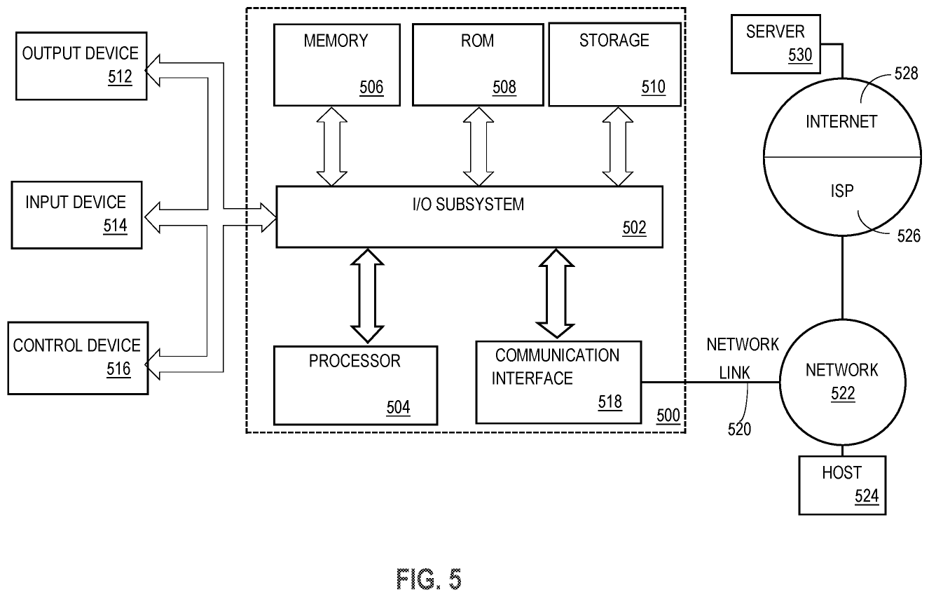

FIG. 5 is a block diagram that illustrates an example computer system with which an embodiment may be implemented. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 500 includes an input/output (I/O) subsystem 502 which may include a bus and/or other communication mechanism(s) for communicating information and/or instructions between the components of the computer system 500 over electronic signal paths. The I/O subsystem 502 may include an I/O controller, a memory controller and at least one I/O port. The electronic signal paths are represented schematically in the drawings, for example as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor or ARM processor. Processor 504 may comprise an integrated arithmetic logic unit (ALU) or may be coupled to a separate ALU.

Computer system 500 includes one or more units of memory 506, such as a main memory, which is coupled to I/O subsystem 502 for electronically digitally storing data and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, can render computer system 500 into a special-purpose machine that is customized to perform the operations specified in the instructions.

Computer system 500 further includes non-volatile memory such as read only memory (ROM) 508 or other static storage device coupled to I/O subsystem 502 for storing information and instructions for processor 504. The ROM 508 may include various forms of programmable ROM (PROM) such as erasable PROM (EPROM) or electrically erasable PROM (EEPROM). A unit of persistent storage 510 may include various forms of non-volatile RAM (NVRAM), such as FLASH memory, or solid-state storage, magnetic disk or optical disk such as CD-ROM or DVD-ROM and may be coupled to I/O subsystem 502 for storing information and instructions. Storage 510 is an example of a non-transitory computer-readable medium that may be used to store instructions and data which when executed by the processor 504 cause performing computer-implemented methods to execute the techniques herein.

The instructions in memory 506, ROM 508 or storage 510 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 500 may be coupled via I/O subsystem 502 to at least one output device 512. In one embodiment, output device 512 is a digital computer display. Examples of a display that may be used in various embodiments include a touch screen display or a light-emitting diode (LED) display or a liquid crystal display (LCD) or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators or servos.

At least one input device 514 is coupled to I/O subsystem 502 for communicating signals, data, command selections or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

In another embodiment, computer system 500 may comprise an internet of things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware and interfaces for generating position reporting packets, notifications, pulse or heartbeat signals, or other recurring data transmissions that specify a position of the computer system 500, alone or in combination with other application-specific data, directed toward host computer 524 or server 530.

Computer system 500 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying at least one sequence of at least one instruction to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage 510 either before or after execution by processor 504.

Computer system 500 also includes a communication interface 518 coupled to bus of I/O subsystem 502. Communication interface 518 provides a two-way data communication coupling to network link(s) 520 that are directly or indirectly connected to at least one communication networks, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 522 broadly represents a local area network (LAN), wide-area network (WAN), campus network, internetwork or any combination thereof. Communication interface 518 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic or optical signals over signal paths that carry digital data streams representing various types of information.

Network link 520 typically provides electrical, electromagnetic, or optical data communication directly or through at least one network to other data devices, using, for example, satellite, cellular, Wi-Fi, or BLUETOOTH technology. For example, network link 520 may provide a connection through a network 522 to a host computer 524.

Furthermore, network link 520 may provide a connection through network 522 or to other computing devices via internetworking devices and/or computers that are operated by an Internet Service Provider (ISP) 526. ISP 526 provides data communication services through a world-wide packet data communication network represented as internet 528. A server computer 530 may be coupled to internet 528. Server 530 broadly represents any computer, data center, virtual machine or virtual computing instance with or without a hypervisor, or computer executing a containerized program system such as DOCKER or KUBERNETES. Server 530 may represent an electronic digital service that is implemented using more than one computer or instance and that is accessed and used by transmitting web services requests, uniform resource locator (URL) strings with parameters in HTTP payloads, API calls, app services calls, or other service calls. Computer system 500 and server 530 may form elements of a distributed computing system that includes other computers, a processing cluster, server farm or other organization of computers that cooperate to perform tasks or execute applications or services. Server 530 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 530 may comprise a web application server that hosts a presentation layer, application layer and data storage layer such as a relational database system using structured query language (SQL) or no SQL, an object store, a graph database, a flat file system or other data storage.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage 510, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
a processing system having a processor; and
a computer memory including:
a set of stored program rules specific to a supplier account;
a cached balance value for a card account associated with an end user; and
instructions that, when executed by the processing system, cause the system to carry out operations comprising:
receiving, at a transaction processing server, an authorization request from a payment network for a transaction between the end user and the supplier account, wherein the card account of the end user has a current card balance value of zero in the authorization request;
sending, from the transaction processing server, an approval request with transaction details of the authorization request to a supplier computer for approval to complete the transaction by the supplier account;
determining that the supplier computer is offline based on a timeout period elapsing without receiving an approval response from the supplier computer for the authorization request;
based on the supplier computer being offline, determining to approve the authorization request at the transaction processing server on behalf of the supplier account based on the set of stored program rules specific to the supplier account and the cached balance value for the card account;
based on approving the authorization request on behalf of the supplier account, transmitting a programmatic call to a funding source computer to transfer funds from a funding account linked to the card account;
transmitting, to a payment network computer, a response message specifying approval of the transaction by the supplier account; and
updating the cached balance value by debiting an amount of the transaction.

2. The system of claim 1, wherein the operations further comprise:
receiving, at the transaction processing server, thousands of other authorization requests associated with end users and supplier accounts; and
processing the authorization request at the transaction processing server processes in parallel with the thousands of the other authorization requests.

3. The system of claim 2, wherein some of the thousands of the other authorization requests are processed in accordance with sets of stored program rules specific to the supplier accounts when corresponding supplier accounts are unreachable for sending approval requests within timeout periods.

4. The system of claim 1, wherein the operations further comprise determining to approve the authorization request at the transaction processing server on behalf of the supplier account by determining that the cached balance value for the card account stored at the transaction processing server is greater than or equal to the amount of the transaction.

5. The system of claim 1, wherein the operations further comprise:
storing, at the transaction processing server, one or more card state values and account balance values as they existed while processing the authorization request;
detecting the supplier computer being online; and
providing the one or more card state values to the supplier computer for the supplier account.

6. The system of claim 1, wherein:
the operations further comprise receiving, at the transaction processing server, the set of stored program rules from the supplier computer before the supplier computer was determined to be offline; and
the set of stored program rules provides instructions to the transaction processing server for determining when to approve transactions with end users when the supplier account is unreachable to approve the transactions.

7. The system of claim 1, wherein the transaction between the end user and the supplier account originates as a computing device associated with the end user.

8. The system of claim 1, wherein the operations further comprise:
receiving an additional programmatic call to update the cached balance value when the supplier computer is online, the additional programmatic call including a new cached balance value; and
updating, in a database of a digital storage device of the transaction processing server, the cached balance value by writing the new cached balance value to the card account.

9. The system of claim 1, wherein the operations further comprise:
transmitting a second authorization request message to the supplier computer comprising second transaction details corresponding to a second transaction between a second end user and the supplier account;
receiving a second response message from the supplier computer specifying to allow the second transaction; and
updating, in a database of a digital storage device at the transaction processing server, the cached balance value of a second card account associated with the second end user by writing a new cached balance value to the second card account.

10. The system of claim 9, wherein the operations further comprise:
receiving an additional programmatic call from the supplier computer to retrieve the cached balance value when the supplier computer is online;
querying the database of the digital storage device to obtain the cached balance value for the card account; and
transmitting an additional response message to the supplier computer that includes the cached balance value.

11. The system of claim 1, wherein the operations further comprise storing the cached balance value for the card account at the transaction processing server in response to a configuration request of the supplier account before the authorization request was received.

12. The system of claim 1, wherein the operations further comprise storing, in a database of a digital storage device at the transaction processing server, one or more webhooks specifying account balance values as they existed before and after processing the authorization request.

13. The system of claim 1, wherein the operations further comprise processing the authorization request at the transaction processing server and other authorization requests within a maximum response time per request of seven (7) seconds.

14. The system of claim 1, wherein the supplier account is one of a retailer, a reseller, a value-added reseller, a distributor, or another entity in a supply chain or manufacturing chain.

15. A transaction processing server, comprising:
a processor; and
a computer memory including:
a set of stored program rules specific to a supplier account;
a cached balance value for a card account associated with an end user; and
instructions that, when executed by the processor, cause the transaction processing server to carry out operations comprising:
receiving an authorization request from a payment network for a transaction between the end user and the supplier account, wherein the card account identified in the authorization request has a current card balance value of zero;
sending an approval request with transaction details of the authorization request to a supplier computer associated with the supplier account for approval to complete the transaction;
determining that the supplier computer is offline;
based on the supplier computer being offline and unable to approve the authorization request to complete the transaction, determining to approve the authorization request on behalf of the supplier account based on:
the set of stored program rules specific to the supplier account; and
the cached balance value for the card account being greater than or equal to an amount of the transaction;
based on approving the authorization request on behalf of the supplier account, transmitting a programmatic call to a funding source computer to transfer funds from a funding account linked to the card account;
transmitting, to a payment network computer, a response message specifying approval of the transaction by the supplier account; and
updating the cached balance value by debiting the amount of the transaction.

16. The transaction processing server of claim 15, wherein the operations further comprise:
receiving thousands of other authorization requests associated with end users and supplier accounts; and
processing the authorization request at the transaction processing server processes in parallel with the thousands of the other authorization requests.

17. The transaction processing server of claim 16, wherein some of the thousands of the other authorization requests are processed in accordance with sets of stored program rules specific to the supplier accounts when corresponding supplier accounts are unreachable for sending approval requests within timeout periods.

18. The transaction processing server of claim 15, wherein the operations further comprise:
storing, at the transaction processing server, one or more card state values and account balance values as they existed while processing the authorization request;
detecting the supplier computer being online; and
providing the one or more card state values to the supplier computer for the supplier account.

19. A computer-implemented method, comprising:
receiving, at a transaction processing server and, an authorization request from a payment network for a transaction between an end user and a supplier account, wherein a card account identified in the authorization request has a current card balance value of zero;
sending transaction details of the authorization request to a supplier computer associated with the supplier account for approval to complete the transaction;
determining that the supplier computer is offline;
based on the supplier computer being offline and unable to approve the authorization request to complete the transaction, determining to approve the authorization request at the transaction processing server on behalf of the supplier account by implementing a set of stored program rules specific to the supplier account;
based on approving the authorization request on behalf of the supplier account, transmitting a programmatic call to a funding source computer to transfer funds from a funding account linked to the card account;
transmitting, to a payment network computer, a response message specifying approval of the transaction by the supplier account;
storing, at the transaction processing server, one or more card state values and account balance values as they existed while processing the authorization request;
detecting the supplier computer being online; and
providing the one or more card state values to the supplier computer for the supplier account.

20. The computer-implemented method of claim 19, further comprising:
receiving, at the transaction processing server, thousands of other authorization requests associated with end users and supplier accounts; and
processing the authorization request at the transaction processing server processes in parallel with the thousands of the other authorization requests,
wherein some of the thousands of the other authorization requests are processed in accordance with sets of stored program rules specific to the supplier accounts when corresponding supplier accounts are unreachable.
